(19) United States
(12) Patent Application Publication
(10) Pub. No.: US 2002/0085536 A1
(43) Pub. Date: Jul. 4, 2002

(54) System and method for implementing a wireless isochronous data service

(76) Inventor: Ashok N. Rudrapatna, Basking Ridge, NJ (US)

Correspondence Address: HARNESS, DICKEY & PIERCE, P.L.C., P.O. BOX 8910, RESTON, VA, 20195, US

(21) Appl. No.: 09/750,216

(22) Filed: Dec. 29, 2000

(51) Int. Cl. H04L 12/66; H04J 3/22

(52) U.S. Cl. 370/352; 370/465; 370/351

(57) ABSTRACT

A method and apparatus for selectively transmitting delay sensitive data (especially streaming data such as voice, video, and multimedia) via a wireless communication connection (including, for example, cellular telephone) in order to improve the quality of service while economizing on system resources by sending (delay insensitive data using IP packet technology in a known manner. The method according to the present invention includes identifying whether transmitted data is delay sensitive or delay insensitive, and using a wireless communication such as cellular telephone to transmit delay sensitive data. A wireless data terminal according to the present invention includes a data analyzer for determining whether data being transmitted is delay sensitive or delay insensitive, a wireless transmission system for transmitting delay sensitive data, and a wireless packet data transmission system for transmitting delay insensitive data.

### FIELD OF THE INVENTION

The present invention relates to a system and method for providing an isochronous data service using a wireless data device. In particular, the present invention relates to a system and method for providing data transmission to and from a wireless data device so as to provide improved quality of service.

### BACKGROUND OF THE PRESENT INVENTION

Wireless data device are becoming increasingly popular for data transmission. Most conventional wireless data devices support and use the Internet Protocol (“IP”) to provide relatively well-known best-effort data services, such as textual World Wide Web browsing and electronic mail. However, there is motivation to provide greater wireless functionality, comparable to data service available from a desktop terminal. Examples are the desire to provide a wireless data device with wireless IP telephony and streaming video functionality.

FIG. 1 illustrates a conventional landline-based data transmission system by way of the Internet or an intranet. In general, a telephony-equipped terminal 100 is connected, through the Internet/intranet 102, to, for example, another telephony-equipped terminal 104, a PSTN 106 (to which a conventional PSTN telephone 108 is connected), or an IP telephony-enabled telephone 110 connected directly to the Internet/intranet 102.

In general, the arrangement illustrated in FIG. 1 uses Internet Protocol (“IP”) packet data communication to transmit data across the Internet/intranet 102 in a well-known manner. IP packet data communication is well-suited for “traditional” data services such as World Wide Web browsing, electronic mail, etc. However, packet data transmission of this type is not as desirable for use with voice telephony (or other streaming data services).

In particular, streaming data such as voice (as well as video and multimedia) is extremely delay sensitive, since a consistent rate of data transmission (hence, “isochronous” data transmission) has to be maintained in order to ensure good quality of service for the data recipient. Unfortunately, IP packet transmission introduces just this kind of variable delay by using burst transmission of data packets. As a result, data packets typically may travel over different paths and/or out of order. Therefore, significant (from a quality of service perspective) time is required to reassemble the packets at the destination, thereby adversely affecting quality of service. In addition, the rate at which packets arrive at the destination is frequently irregular, which also negatively affects quality of service.

A wireless data network (such as, for example, CDMA 2000, Metricom, RAM Mobile, ARDIS, and XWD) also introduces delays, For example, noise and signal interference generally causes bad frames between the transmitter and receiver, requiring data retransmission since wireless networks of this type are typically not fault-tolerant.

Moreover, mobility is a factor in wireless data networks, which means handoffs between base stations must be considered. This also cause delays in data transmission.

### SUMMARY OF THE PRESENT INVENTON

In view of the foregoing, the present invention relates to a system and method for providing IP-type functionality in a wireless data system, using an alternative, comparatively robust, communication system (such as cellular telephone) that can ensure good quality of services for end users. Cellular and other wireless circuit switched networks are optimized for quality of services (QoS) guaranteed (i.e., low delay and error) services via well-known techniques (e.g., power control). Likewise, wireless data networks are optimized for best-effort relatively delay insensitive traffic by using other techniques, such as rate control and retransmission mechanisms resulting in efficient (i.e., low power consumption) error free service associated with higher delay. The system and method according to the present invention relies on selective emulation of IP-based packet data transmission to support IP-based realtime services using wireless circuit switched communication instead of actual packet data transmission. This will provide these services in a manner that will be totally transparent to end users while being cost-effective and timely without performance degradation. In particular, the present invention calls for identifying whether data being transmitted is delay sensitive or delay insensitive. For delay sensitive data, alternative wireless communication (such as cellular telephone) is used to convey to data. For delay insensitive data, IP packet transmission across the Internet, an intranet, or the like (as in the conventional case) is used. Thus, system design is optimized for both types of traffic.

The present invention is therefore beneficial in terms of simultaneously optimizing the quality of services issues encountered when conveying streaming data using IP packet transmission, and transmission delay insensitive data using packet transmission in the conventional manner.

### BRIEF DESCRIPTION OF THE DRAWINGS

FIG. 1 is a schematic illustration of a landline Internet/intranet based voice telephony call;

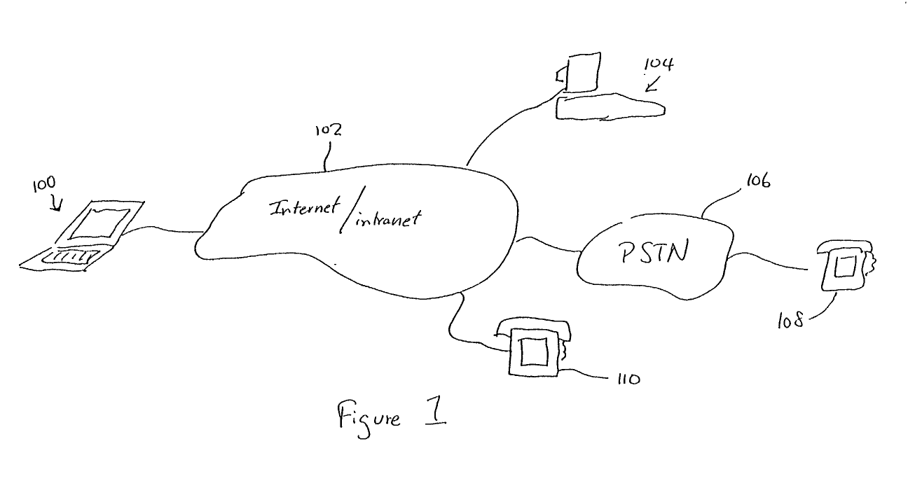

FIG. 2 is a schematic illustration of a communication arrangement using a wireless data device according to the present invention;

FIG. 3 is a schematic illustration illustrating a data structure, particularly pointing out elements of the data structure used in connection with the present invention;

FIG. 4 is flow chart illustrating the process of placing a call from a wireless data device to a PSTN telephone according to the present invention;

FIG. 5 is flow chart illustrating the process of placing a call from a PSTN telephone to a wireless data device according to the present invention;

FIG. 6 is a flow chart illustrating the process of placing a call from a wireless data device to an Internet/intranet based IP telephone according to the present invention; and

FIG. 7 is a flow chart illustrating the process of placing a cal from an Internet/intranet based IP telephone to a wireless data device according to the present invention.

### DETAILED DESCRIPTION OF THE PRESENT INVENTION

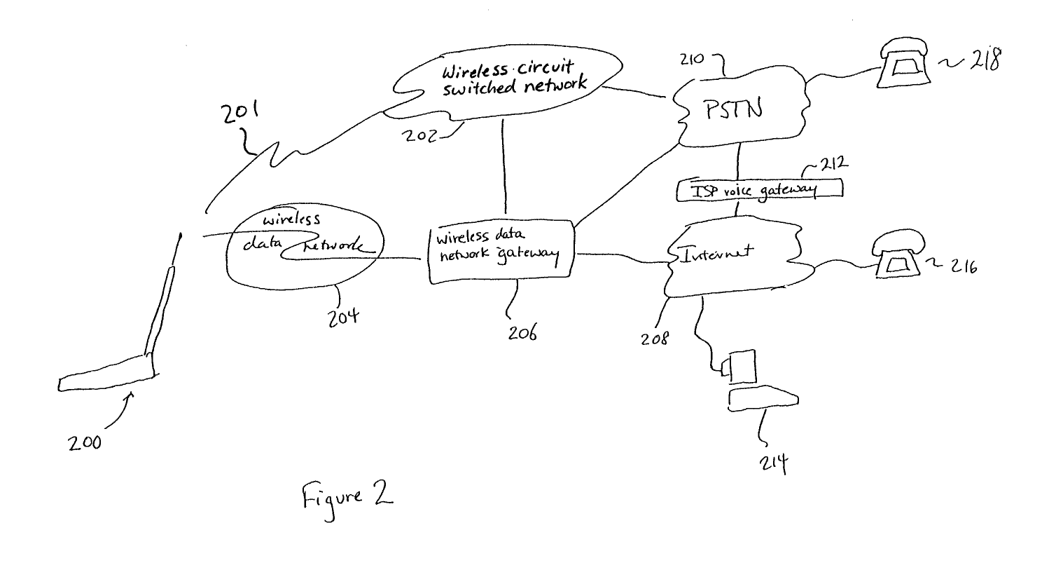

FIG. 2 illustrates a communication system in accordance with the present invention. It is to be noted that telephony is used solely as an illustrative example hereinbelow to describe the present invention, and is not otherwise to be taken as limiting the scope of the present invention. Other examples are video telephony and streaming video.

A wireless data terminal 200 (which may be, without limitation, a laptop computer, a “dumb” computer terminal, a personal data assistant, a PC computer, etc.) is configured for access to wireless data networks along with (but not necessarily only) wireless circuit switched networks. This may be accomplished in any number of ways readily known to one of ordinary skill in the field of wireless communication. In one example according to the present invention, the terminal 200 is provided with a peripheral “plug-in” card having the necessary and known circuitry thereon to process, for example, a cellular connection (or a PCS connection, a radio connection, etc.). Implementing cellular/PCS telephone functionality may be hardware implemented, software implemented, or a combination. Of course, any required ancillary equipment (e.g., antennae) is provided with the terminal 200, as may be needed.

Terminal 200 will additionally communicate in a conventional manner with a wireless data network 204 (such as a wireless LAN or the like, including, without limitation, wide area wireless data networks).

The wireless data network 204 is connected to the Internet (or an intranet) 208 by way of a gateway server 206, for example. Gateway server 206 may also function to connect the wireless data network 206 to wireless circuit switched network 202 and/or PSTN 210 using known technologies.

The reference to a wireless circuit switched network 202 here is strictly by way of example, only, and the present invention as contemplated is equally applicable to wireless communication technologies such as cellular, PCS, fixed wireless, satellite based voice networks, and the like. The wireless circuit switched network 202 is configured in a manner know in the art and is therefore not discussed in detail here.

Finally, Internet 208 can communicate with PSTN 210 via, for example, a voice gateway server 212 (that is be provided by, for example, an Internet service provider).

Thus, terminal 200 can communicate with a PC computer 214 (or the like) connected to the Internet 208 or with an IP telephony-enabled telephone 216 connected to Internet 208. Likewise, terminal 200 can communicate with a PSTN telephone 218. It is noted that the arrangement illustrated in FIG. 2 is strictly by way of example, and other arrangements and connections are equally possible within the skill of one knowledgeable in the art.

In order to illustrate the present invention, several working examples are set forth in detail below (again, using telephony as an example):

1) A call from a wireless data terminal to a PSTN phone;

2) A call from a PSTN telephone to a wireless data terminal;

3) A call from a wireless data terminal to an Internet-connected IP telephone; and

4) A call from an Internet-connected IP telephone to a wireless data terminal.

It will be appreciated that reference to an “Internet-connected IP telephone” may include, for example, a Internet-connected PC computer configured to act as an IP telephone. It will further be appreciated that the foregoing examples are merely illustrative of the present invention, and that other communication systems may be provided in accordance with the present invention, all including the use of a wireless data device or terminal as discussed hereinbelow.

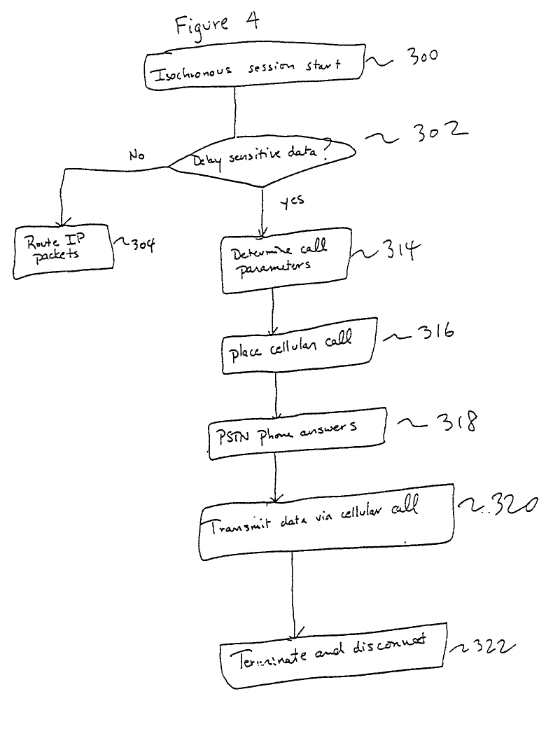

FIG. 4 is a flow chart illustrating a call from a wireless data terminal to a PSTN phone (e.g., a call from terminal 200 to PSTN phone 218, as seen in FIG. 2). It is noted that the concept of a “call” here is intended to refer, generally, to establishing a data transmission connection that needs to support delay sensitive quality of service traffic.

When a call from a wireless data terminal 200 is placed (step 300), the data (which is usually initially in IP packet form) that is to be sent from terminal 200 to PSTN phone 218 is identified as being either delay sensitive or delay insensitive (step 302). This identification may be performed, for example, either on-board the terminal 200 or externally thereto. The identification process may be hardware based on, for example, a peripheral card in terminal 200, or it may be software based, and carried out by appropriate processors and the like resident in terminal 200.

If the data is delay insensitive (i.e., “no” in step 302), the packet data is routed (in a known manner using existing wireless data network methods) via wireless data network 204 and gateway server 206 (in a transparent pass-through manner) so as to be transmitted across the Internet 208 (step 304) to its destination (for example, terminal 214).

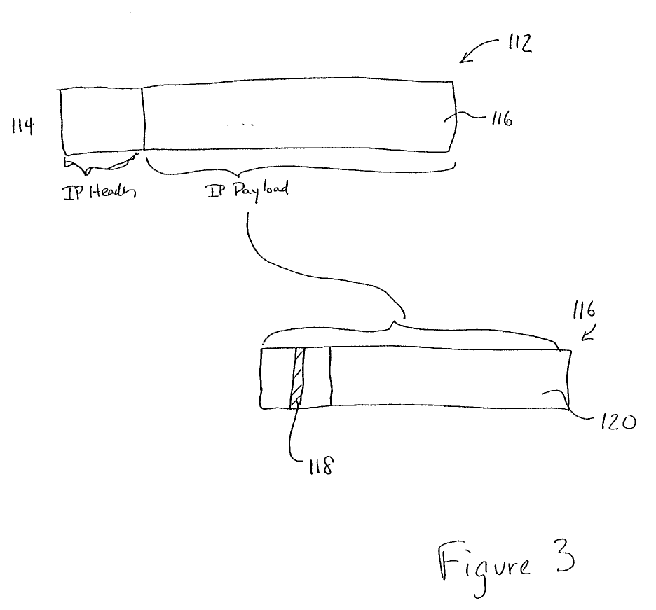

If the transmitted data is identified as being delay sensitive in step 302, then the parameters (phone number, data rate, etc.) for placing a cellular call (a cellular call is used here as an example) are obtained from the data being transmitted (see, for example, the discussed of FIG. 3 below) (step 314). A cellular call is then placed by terminal 200 via connection 201, using known hardware and/or software provided, for example, as part of terminal 200 (step 316). As mentioned above, the cellular call made via wireless circuit switched network 202 is placed in a manner well-known in the field of cellular wireless communication, so a detailed description is omitted here.

Wireless circuit switched network 202 is connected to PSTN 210 in a well-known manner, so the cellular call from terminal 200 is connected to PSTN phone 218 (step 318). Once PSTN phone 218 answers the call, the delay sensitive information is transmitted between terminal 200 and PSTN phone 218 by way of wireless circuit switched network 202 (step 320) until the call is terminated and disconnected in a known way (step 322).

Alternatively, when delay sensitive data is being transmitted, terminal 200 may communicate with wireless circuit switched network 202 via wireless data network 204 (including gateway server 206). In this case, terminal 200 may not necessarily be equipped to place a cellular call, and only requires the known hardware and/or software to communicate with the convention wireless data network 204. Instead, for example, the wireless data network 204 (especially gateway server 206) may be configured to establish a cellular connection. The routing of the call from wireless circuit switched network 202 to PSTN phone 218 is thereafter the same as discussed above.

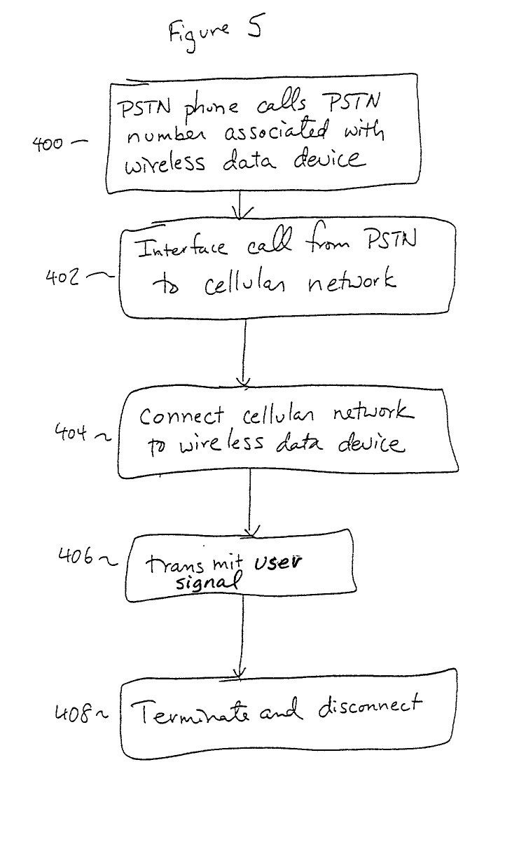

FIG. 5 illustrates the placing of a call from a PSTN phone 218 to terminal 200. In step 400, PSTN phone 218 calls a PSTN phone number associated with the terminal 200. The call is interfaced between PSTN and wireless circuit switched network 202 in a known and standard manner (step 402). In turn, a cellular call connection is established between wireless circuit switched network 202 and terminal 200 (step 404) thus establishing the end-to-end connection. Alternatively, the call may be directed to gateway server 206, which may be configured to identify whether the data being transmitted is delay sensitive so as to send the data by way of wireless circuit switched network 202 or wireless data network 204, as may be appropriate.

A user signal (e.g., a voice call) is transmitted between PSTN phone 218 and terminal 200 using the thusly established connection (step 406). Once the call is completed, the call is terminated and disconnected in a known manner (step 408). It will be appreciated that it may be necessary to provide a conversion between packet data used by the terminal 200 and the circuit-switched connection of wireless circuit switched network 202 and PSTN 210. This can be performed at the terminal.

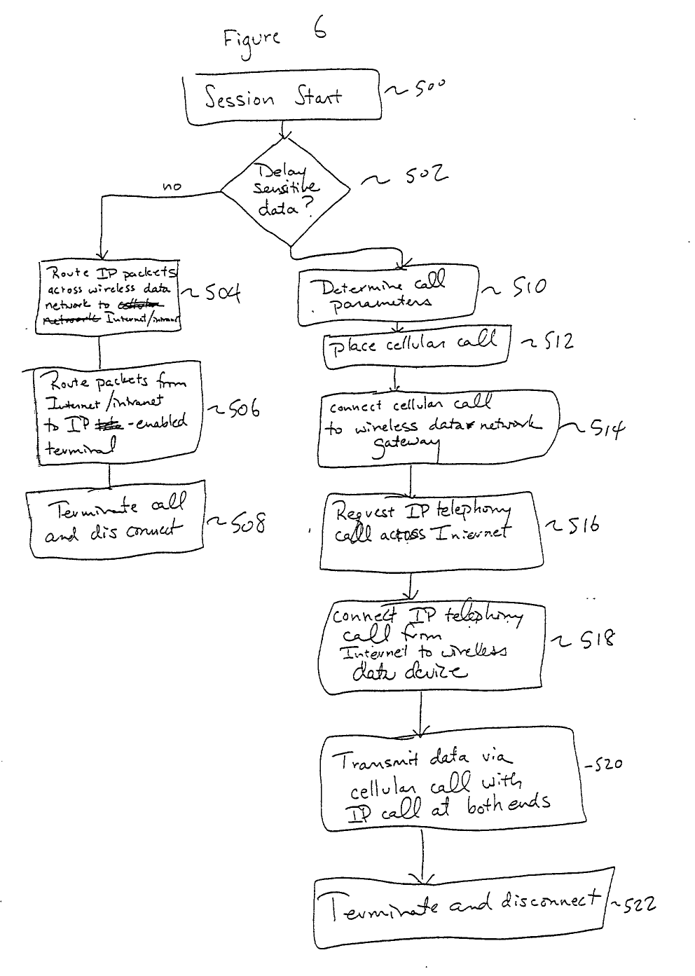

FIG. 6 illustrates the placing of a call from a wireless data terminal to an IP-enabled telephone (such as telephone 216, in FIG. 2). As mentioned above, this example may be equally applied to a connection with an IP telephony configured PC computer 214 or the like, as seen in FIG. 2.

As in the other embodiments, a call from the wireless data terminal 200 is initiated at step 500. At step 502, a determination is made if the data being transmitted is delay sensitive. If the data is delay insensitive (i.e., “no” at step 502), then the data is sent via wireless data network 204 and gateway server 206 across the Internet 208 (step 504), from where it is routed to the IP address of the IP-enabled telephone 216 (or, alternatively, telephony-equipped computer 214, etc.) in accordance with known IP telephony protocols (step 506). Once the transmission of the delay insensitive data is complete, the Call is terminated and disconnected in a known manner (step 508).

If the data being transmitted is delay sensitive (i.e., “yes” at step 502), then the parameters for placing a cellular call (e.g., phone number, data transmission rate, etc.) are determined (step 510), and a cellular call is placed via a wireless circuit switched network 202 using link 201 and gateway server 206 (step 514). At gateway server 206, and IP telephony call is initiated (over Internet 208) in a known manner (step 516). As a result, an IP telephony call is connected with the cellular call, via gateway server 206 (step 518). The delay sensitive data is transmitted as a cellular call in the middle with packet transmission at both ends of the call (step 520). Accordingly, the packet data transmission is converted to a circuit-switched transmission at both ends of the call (e.g., at the terminal 200 and at gateway server 206). At the conclusion of data transmission, the call is terminated and disconnected in a known manner (step 522).

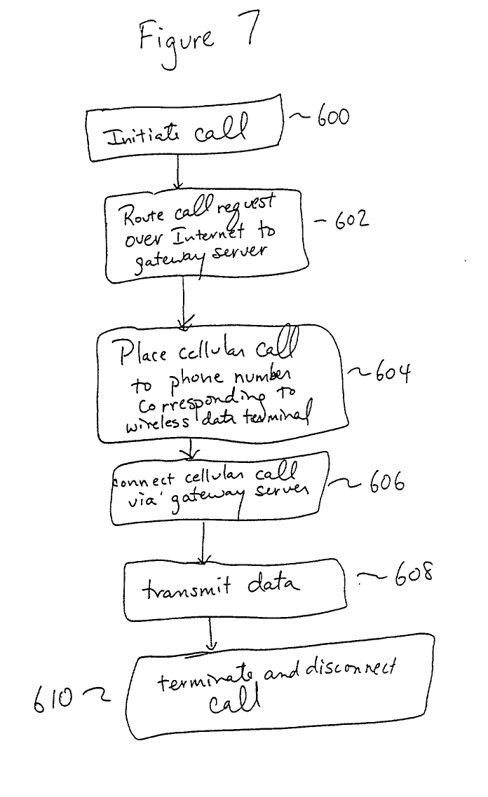

FIG. 7 illustrates the placing of a call from an IP-enabled telephone 216 to wireless data terminal 200.

IP-enabled telephone 216 initiates an IP telephony call in a known manner (step 600) which is routed across Internet 208 to gateway server 206 (step 602). The gateway server 206 in turn initiates a corresponding cellular telephone call across wireless circuit switched network 202 to the phone number corresponding to the terminal 200 (step 604). Thus, a cellular call is connected between terminal 200 and gateway server 206 (step 606). Data is transmitted, as desired, across the resultant connection (step 608). Thereafter, the call is terminated and disconnected in a known manner (step 610).

As noted above, it is a significant feature of the present invention to identify and distinguish data that is delay sensitive from data that is delay insensitive. In one embodiment of the present invention, data by the wireless data device is initially in packet form, such as packet 112, shown in FIG. 3. Thus, identifying whether the data therein is delay sensitive or not includes identifying an application identifier in the header 114 of the each data packet 112. In particular, if the application identifier corresponds with the User Datagram Protocol (UDP), this indicates that the packet payload 116 may contain streaming data, such as voice, video, or multimedia. Thus, the payload 116 is examined upon detection of the UDP identifier in the packet header. The payload 116, in turn, contains a protocol identifier 118 that indicates what type of data is contained in payload 116, and information regarding call parameters, such as the destination phone number. This information is used to translate and transfer between circuit switched and packet switched modes.

The invention being thus described, it will be obvious that the same may be varied in may ways. Such variations are not to be regarded as a departure from the spirit and scope of the invention, and all such modifications as would be obvious to one skilled in the art are intended to be included within the scope of the following claims.

What is claimed is:

1. A method for transmitting data comprising:
identifying if data being transmitted is delay sensitive or delay insensitive;
using packet transmission to transit delay insensitive data; and
establishing a wireless communication connection to transmit delay sensitive data.

2. The method according to claim 1, wherein using packet transmission comprises using Internet Protocol packet transmission.

3. The method according to claim 1, wherein establishing a wireless communication connection comprises establishing one of a wireless circuit switched communication connection, a Personal Communication System connection, and a radio connection.

4. The method according to Claim 1, wherein establishing a wireless communication connection comprises establishing a wireless circuit switched communication connection.

5. The method according to claim 4, wherein establishing a wireless circuit switched communication connection includes determining call parameters for establishing the wireless circuit switch communication connection.

6. The method according to claim 5, wherein determining call parameters for establishing the wireless circuit switched communication connection comprises extracting call parameter information from the data being transmitted.

7. The method according to claim 5, wherein determining call parameters for establishing the wireless circuit switched communication connection includes at least one of identifying a call destination and determining a rate of data transmission.

8. The method according to claim 4, further comprising connecting the wireless circuit switched communication connection with a PSTN.

9. The method according to claim 4, further comprising connecting the wireless circuit switched communication connection with the Internet.

10. The method according to claim 9, wherein connecting the wireless circuit switched communication connection with the Internet includes providing a gateway server operatively between a wireless circuit switched communication network and the Internet.

11. The method according to claim 2, wherein using packet transmission to transmit delay insensitive data comprises using packet transmission to send data over the Internet.

12. The method according to claim 11, further comprising connecting the Internet connection to a PSTN.

13. The method according to claim 1, wherein the delay sensitive data includes one or more of voice data, video data, and multimedia data.

14. The method according to claim 1, wherein the data being transmitted is multimedia data comprising a delay sensitive portion and a delay insensitive portion, the delay sensitive portion being transmitted by the wireless communication connection and the delay insensitive portion being transmitted by packet transmission.

15. The method according to claim 1, wherein the data being transmitted is initially packetized, each data packet comprising a header and payload, wherein identifying if the data being transmitted is delay sensitive or delay insensitive comprises:
identifying an application identifier in a respective packet header; and
depending on the application identifier, examining the packet payload.

16. The method according to claim 15, wherein identifying an application identifier comprises determining if the application identifier corresponds to the User Datagram Protocol.

17. The method according to claim 16, comprising examining the data packet payload if the application identifier corresponds to the User Data Protocol.

18. The method according to claim 16, wherein examining the data packet payload comprises identifying if the data packet payload contains voice data.

19. The method according to claim 16, wherein examining the data packet payload comprises identifying if the data packet payload contains video data.

20. The method according to claim 16, wherein examining the data packet payload comprises identifying if the data packet payload contains multimedia data.

21. A method for transmitting data between a first node and a second node, comprising:
identifying if data transmitted is delay sensitive or delay insensitive;
using packet transmission to transmit delay insensitive data; and
establishing a wireless communication connection to transmit delay sensitive data.

22. The method according to claim 21, wherein the first node is a wireless data terminal and the second node is on a PSTN.

23. The method according to claim 22, wherein delay sensitive data is transmitted between the first node and the second node by way of a cellular network.

24. The method according to claim 23, wherein delay insensitive data is transmitted between the first node and the second node by way of the Internet.

25. The method according to claim 21, wherein the first node is a wireless data terminal and the second node is on the Internet.

26. The method according to claim 25, wherein delay insensitive data is transmitted between the first node and the second node by way of a wireless data network.

27. The method according to claim 26, comprising providing a gateway server between the wireless data network and the Internet.

28. The method according to claim 25, wherein delay sensitive data is transmitted between the first node and the second node by way of a cellular network.

29. The method according to claim 28, comprising providing a gateway server between the cellular network and the Internet.

30. The method according to claim 21, wherein the first node is on a PSTN and the second node is a wireless data terminal.

31. The method according to claim 30, wherein delay sensitive data is transmitted from the first node of the second node by way of a cellular network.

32. The method according to claim 21, wherein the first node is on the Internet and the second node is a wireless data terminal.

33. The method according to claim 32, wherein delay sensitive data is transmitted from the first node to the second node by way of a cellular network.

34. The method according to claim 33, comprising providing a gateway server operatively between the Internet an the cellular network.

35. A wireless data terminal comprising:
a data analyzer for identifying whether data transmitted by the terminal is delay sensitive or delay insensitive;
a wireless circuit transmission system for transmitting delay sensitive data; and
a wireless packet transmission system for transmitting delay insensitive data.

36. The terminal according to claim 35, wherein said wireless transmission system is constructed and arranged to establish a wireless circuit switched communication connection.

37. The terminal according to claim 36, wherein said wireless transmission system comprises a computer peripheral card.

38. The terminal according to claim 35, wherein said packet transmission system is constructed and arranged to communicate with a packet data network.

39. The terminal according to claim 38, wherein the packet transmission system is constructed and arranged to communicate with a wireless data network.

40. The terminal according to claim 38, wherein the packet transmission system is constructed and arranged to communicate with the Internet.

41. A data communication network comprises a node on the data communication network constructed and arranged to selectively communicate with a cellular communication network or a wireless data network depending on whether data being sent to or received by the node is delay sensitive or delay insensitive.

42. The network according to claim 41, wherein the node is a wireless data terminal.
